(19) United States
(12) Patent Application Publication
(10) Pub. No.: US 2025/0328043 A1
(43) Pub. Date: Oct. 23, 2025

(54) DISPLAY DEVICE

(71) Applicant: Japan Display Inc., Tokyo (JP)

(72) Inventors: Kazuki ICHIHARA, Tokyo (JP); Shuji HAYASHI, Tokyo (JP)

(21) Appl. No.: 19/175,876

(22) Filed: Apr. 10, 2025

(30) Foreign Application Priority Data
Apr. 19, 2024 (JP) 2024-068332

(51) Int. Cl. G02F 1/1335; G02F 1/1343; G02F 1/153

(52) U.S. Cl. CPC G02F 1/133512; G02F 1/134336; G02F 1/1533

(57) ABSTRACT

According to an aspect, a display device includes: a display panel that has a display area in which a plurality of pixels are arranged in a first direction and a second direction intersecting the first direction, and that is configured to make an image viewed in plan view from one side of the display area visible from another side; a first light control panel that is provided on one surface of the display panel and is configured to make at least a partial area of the display area invisible; and a second light control panel that is provided on another surface of the display panel and is configured to make at least a partial area of the display area invisible.

### CROSS-REFERENCE TO RELATED APPLICATION

This application claims the benefit of priority from Japanese Patent Application No. 2024-068332 filed on Apr. 19, 2024, the entire contents of which are incorporated herein by reference.

### BACKGROUND

### 1. Technical Field

What is disclosed herein relates to a display device.

### 2. Description of the Related Art

A display device is disclosed that is configured to allow a viewer to view, from one surface side of a display panel, a background on the other surface side thereof. Such a display device is what is called a see-through display and includes a display panel having a liquid crystal layer containing polymer-dispersed liquid crystals, and a light source located so as to face a lateral surface of the display panel. A see-through display is configured as a self-luminous organic electroluminescent (EL) display device in which an interlayer insulating film and a planarizing film in a display area are removed.

In the see-through display, the same image is visible from both the one surface side and the other surface side of the display panel. However, depending on the displayed content, the image may be preferable to be invisible from the one surface side or the other surface side in at least a part of the display area.

For the foregoing reasons, there is a need for a display device capable of optionally set an area invisible from one surface side or the other surface side.

### SUMMARY

According to an aspect, a display device includes: a display panel that has a display area in which a plurality of pixels are arranged in a first direction and a second direction intersecting the first direction, and that is configured to make an image viewed in plan view from one side of the display area visible from another side; a first light control panel that is provided on one surface of the display panel and is configured to make at least a partial area of the display area invisible; and a second light control panel that is provided on another surface of the display panel and is configured to make at least a partial area of the display area invisible.

### BRIEF DESCRIPTION OF THE DRAWINGS

FIG. 1 is a block diagram illustrating a schematic configuration of a display device according to an embodiment of the present disclosure;

FIG. 2 is a schematic sectional view of a display panel;

FIG. 3 is a timing diagram illustrating sub-frame periods and light emission periods in a one-frame period during which display image data is displayed;

FIG. 4A is a conceptual view of a display state according to a comparative example as viewed in a first visual line direction;

FIG. 4B is a conceptual view of the display state according to the comparative example as viewed in a second visual line direction;

FIG. 5 is a schematic sectional view of a display area in the display device according to the embodiment;

FIG. 6A is a conceptual view of a first display example according to the embodiment as viewed in the first visual line direction;

FIG. 6B is a conceptual view of the first display example according to the embodiment as viewed in the second visual line direction;

FIG. 7 is a schematic sectional view of the display area in the first display example illustrated in FIGS. 6A and 6B;

FIG. 8A is a conceptual view of a second display example according to the embodiment as viewed in the first visual line direction;

FIG. 8B is a conceptual view of the second display example according to the embodiment as viewed in the second visual line direction;

FIG. 9 is a schematic sectional view of the display area in the second display example illustrated in FIGS. 8A and 8B;

FIG. 10A is a conceptual view of a third display example according to the embodiment as viewed in the first visual line direction;

FIG. 10B is a conceptual view of the third display example according to the embodiment as viewed in the second visual line direction;

FIG. 11A is an enlarged view illustrating a first example of a textual-information display area in the third display example according to the embodiment as viewed in the first visual line direction;

FIG. 11B is an enlarged view illustrating the first example of the textual-information display area in the third display example according to the embodiment as viewed in the second visual line direction;

FIG. 12A is a sectional arrow view taken along line A-A illustrated in FIGS. 11A and 11B;

FIG. 12B is a sectional arrow view taken along line B-B illustrated in FIGS. 11A and 11B;

FIG. 13A is an enlarged view illustrating a second example of the textual-information display area in the third display example according to the embodiment as viewed in the first visual line direction;

FIG. 13B is an enlarged view illustrating the second example of the textual-information display area in the third display example according to the embodiment as viewed in the second visual line direction;

FIG. 14A is a sectional arrow view taken along line A-A illustrated in FIGS. 13A and 13B;

FIG. 14B is a sectional arrow view taken along line B-B illustrated in FIGS. 13A and 13B;

FIG. 15A is an enlarged view illustrating a third example of the textual-information display area in the third display example according to the embodiment as viewed in the first visual line direction;

FIG. 15B is an enlarged view illustrating the third example of the textual-information display area in the third display example according to the embodiment as viewed in the second visual line direction;

FIG. 16 is a sectional arrow view taken along line B-B illustrated in FIGS. 15A and 15B;

FIG. 17A is an enlarged view illustrating a fourth example of the textual-information display area in the third display example according to the embodiment as viewed in the first visual line direction;

FIG. 17B is an enlarged view illustrating the fourth example of the textual-information display area in the third display example according to the embodiment as viewed in the second visual line direction;

FIG. 18 is a sectional arrow view taken along line B-B illustrated in FIGS. 17A and 17B;

FIG. 19A is an enlarged view illustrating a fifth example of the textual-information display area in the third display example according to the embodiment as viewed in the first visual line direction;

FIG. 19B is an enlarged view illustrating the fifth example of the textual-information display area in the third display example according to the embodiment as viewed in the second visual line direction;

FIG. 20 is a sectional arrow view taken along line A-A illustrated in FIGS. 19A and 19B;

FIG. 21A is an enlarged view illustrating a sixth example of the textual-information display area in the third display example according to the embodiment as viewed in the first visual line direction;

FIG. 21B is an enlarged view illustrating the sixth example of the textual-information display area in the third display example according to the embodiment as viewed in the second visual line direction; and

FIG. 22 is a sectional arrow view taken along line A-A illustrated in FIGS. 21A and 21B.

### DETAILED DESCRIPTION

The following describes a mode (embodiment) for carrying out the present disclosure in detail with reference to the drawings. The present disclosure is not limited to the description of the embodiment given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the disclosure. To further clarify the description, the drawings schematically illustrate, for example, widths, thicknesses, and shapes of various parts as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

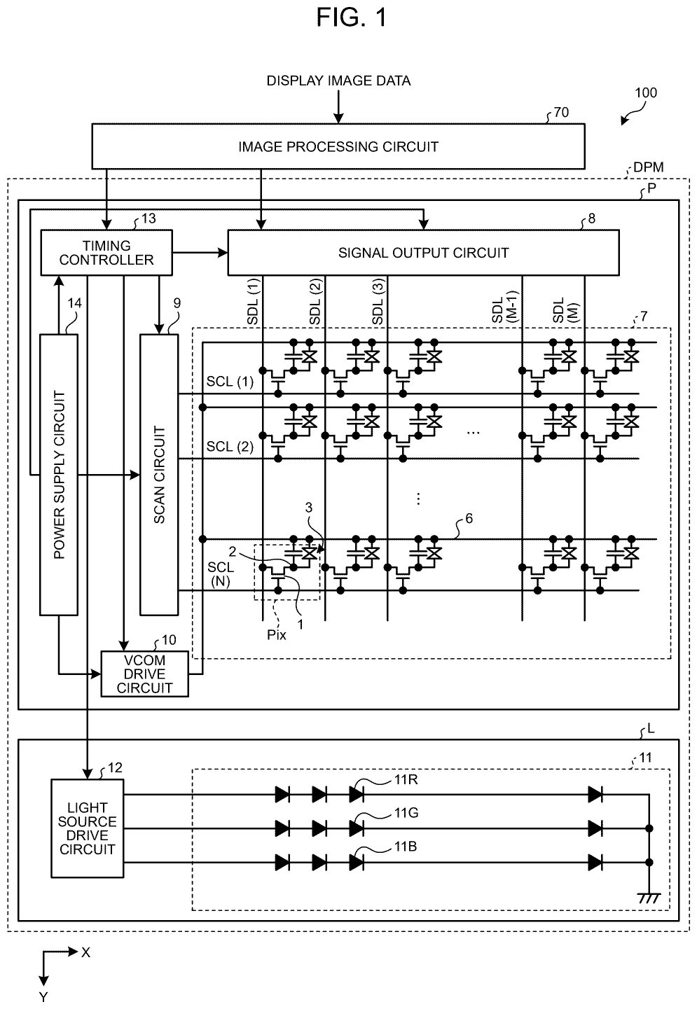

FIG. 1 is a block diagram illustrating a schematic configuration of a display device according to an embodiment of the present disclosure. In the present disclosure, a display device 100 is a transmissive liquid crystal display device that performs display output using what is called a field-sequential color (FSC) system to control pixels so that light in a plurality of colors is transmitted through the same pixels at times different from one another.

As illustrated in FIG. 1, the display device 100 according to the embodiment includes a display panel module DPM and an image processing circuit 70. The display panel module DPM includes a display panel DISP and a light source device L.

The display panel DISP includes a display area 7, a signal output circuit 8, a scan circuit 9, a VCOM drive circuit 10, a timing controller 13, and a power supply circuit 14. Hereafter, one surface of the display panel DISP as viewed in plan view from one side of the display area 7 (hereinafter, “from one side” is also called “in a (the) first visual line direction”) is referred to as a “first surface”, and the other surface on which a mirror image of an image displayed on the first surface is visible from the other side (hereinafter, “from the other side” is also called “in a (the) second visual line direction”) is referred to as a “second surface”. A lateral side of the display device 100 refers to a side located, with respect to the display device 100, in a direction intersecting (at, for example, a right angle) a direction in which the first surface faces the second surface.

A plurality of pixels Pix are arranged in a matrix having a row-column configuration in an X direction (first direction) and a Y direction (second direction) in the display area 7. The Y direction (second direction) is a direction intersecting the X direction (first direction). More specifically, in the example illustrated in FIG. 1, the Y direction (second direction) is a direction orthogonal to the X direction (first direction).

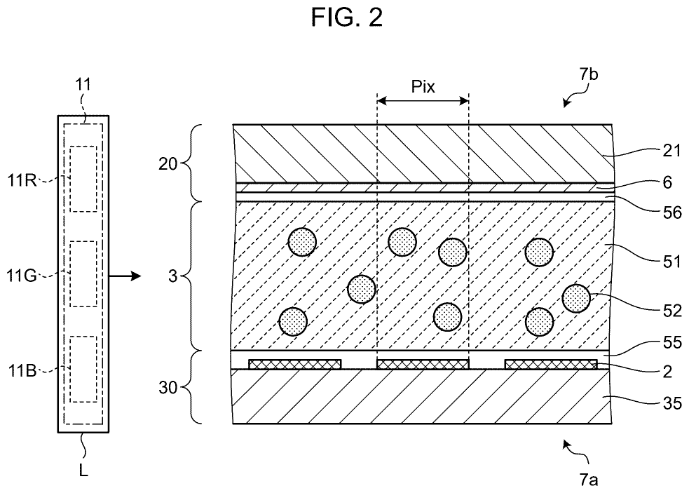

Each of the pixels Pix includes a switching element 1 and two electrodes. FIG. 2 is a schematic sectional view of the display panel. FIGS. 1 and 2 illustrate a pixel electrode 2 and a common electrode 6 as the two electrodes.

The display panel DISP includes two substrates facing each other and liquid crystals 3 enclosed between the two substrates. Hereinafter, one of the two substrates is referred to as a first substrate 30, and the other of them is referred to as a second substrate 20. In the present disclosure, a surface on the first substrate 30 side of the display panel DISP is referred to as a first surface 7a, and a surface on the second substrate 20 side of the display panel DISP is referred to as a second surface 7b.

The first substrate 30 includes a light-transmitting glass substrate 35, the pixel electrode 2 stacked on the second substrate 20 side of the glass substrate 35, and an insulating layer 55 stacked on the second substrate 20 side so as to cover the pixel electrode 2. The pixel electrode 2 is individually provided for each of the pixels Pix. The second substrate 20 includes a light-transmitting glass substrate 21, the common electrode 6 stacked on the first substrate 30 side of the glass substrate 21, and an insulating layer 56 stacked on the first substrate 30 side of the common electrode 6 so as to cover the common electrode 6. The common electrode 6 has a plate-like or film-like shape shared among the pixels Pix.

The liquid crystals 3 of a first embodiment are polymer-dispersed liquid crystals (PDLCs). In other words, in the present embodiment, the display panel DISP is a liquid crystal panel in which the polymer-dispersed liquid crystals are enclosed. Specifically, the liquid crystals 3 include a bulk 51 and fine particles 52. The fine particles 52 change in orientation in the bulk 51 in accordance with a potential difference between the pixel electrode 2 and the common electrode 6. By individually controlling the potential of the pixel electrode 2 for each of the pixels Pix, the scattering state of the liquid crystals 3 is controlled for each of the pixels Pix.

FIG. 2 illustrates an example in which the pixel electrode 2 and the common electrode 6 are arranged so as to face each other with the liquid crystals 3 interposed therebetween. However, the display panel DISP may be configured such that the pixel electrode 2 and the common electrode 6 are provided on one substrate, and an electric field generated by the pixel electrode 2 and the common electrode 6 changes the orientation of the liquid crystals 3 and thus controls the scattering state of the liquid crystals 3.

The following describes a mechanism for controlling the potentials of the pixel electrode 2 and the common electrode 6.

The switching element 1 is a switching element using a semiconductor such as a thin-film transistor (TFT). One of the source and the drain of the switching element 1 is coupled to one of the two electrodes (pixel electrode 2). The other of the source and the drain of the switching element 1 is coupled to a signal line SDL (m) (m is an integer in a range from 1 to M, where M is a total number of the signal lines). The gate of the switching element 1 is coupled to a scan line SCL (n) (n is an integer in a range from 1 to N, where N is a total number of the scan lines). Under the control of the scan circuit 9, the scan line SCL (n) applies a potential to open or close a circuit between the source and the drain of the switching element 1. The scan circuit 9 controls the potential.

In the example illustrated in FIG. 1, a plurality of signal lines SDL (n) are arranged along one of the arrangement directions (row direction) of the pixels Pix. The signal line SDL (m) extends along the other of the arrangement directions (column direction) of the pixels Pix. The signal line SDL (m) is shared by the switching elements 1 of the pixels Pix arranged in the column direction. A plurality of the scan lines SCL (n) are arranged along the column direction. The scan line SCL (n) extends along the row direction. The scan line SCL (n) is shared by the switching elements 1 of the pixels Pix arranged in the row direction.

In the present disclosure, the X direction (first direction) refers to the direction in which the scan line SCL (n) extends, and the Y direction (second direction) refers to the direction in which the scan lines SCL (n) are arranged.

The common electrode 6 is coupled to the VCOM drive circuit 10. The VCOM drive circuit 10 applies a common potential to the common electrode 6.

The scan circuit 9 sequentially supplies a drive signal that serves as an ON potential (drive potential) of the switching elements 1 to the scan lines SCL (n) coupled to the pixels Pix arranged in the X direction (first direction). In other words, the scan circuit 9 simultaneously supplies the drive signal to the pixels Pix arranged in the X direction (first direction). The scan circuit 9 sequentially supplies the drive signal to the pixels Pix arranged in the Y direction (second direction).

The signal output circuit 8 sequentially supplies, to the signal lines SDL (m) coupled to the pixels Pix arranged in the Y direction (second direction), pixel signals that serve as pixel data corresponding to the pixels Pix. In other words, the signal output circuit 8 sequentially supplies the pixel data to the pixels Pix arranged in the Y direction (second direction). The signal output circuit 8 simultaneously supplies the pixel data to the pixels Pix arranged in the X direction (first direction).

When the scan circuit 9 supplies the drive signal to the scan lines SCL (n) and the switching elements 1 of the pixels Pix arranged in the X direction (first direction) are controlled to be turned on, the signal output circuit 8 outputs the pixel signals to the signal lines SDL (m) to charge the liquid crystals 3 (fine particles 52) serving as a storage capacitor and a capacitive load provided between the pixel electrodes 2 of the pixels Pix arranged in the X direction (first direction) and the common electrode 6. As a result, a voltage corresponding to the pixel data of each of the pixels Pix arranged in the X direction (first direction) is applied between the pixel electrode 2 of the pixel Pix and the common electrode 6. The scan circuit 9 sequentially supplies the drive signal to the scan lines SCL (n) arranged in the Y direction (second direction), and the signal output circuit 8 supplies the pixel data corresponding to the pixels Pix coupled to the scan lines SCL (n) supplied with the drive signal by the scan circuit 9. As a result, the pixel data of an image for one sub-frame (a plurality of monochromatic images constituting an image for one frame) is written.

After the switching element 1 is turned off, the voltage applied between the pixel electrode 2 and the common electrode 6 is held by the liquid crystals 3 (fine particles 52) serving as the storage capacitor and the capacitive load. The degree of scattering of the liquid crystals 3 (fine particles 52) is controlled according to the voltage applied between the pixel electrode 2 of each of the pixels Pix and the common electrode 6. The liquid crystals 3 may be, for example, the polymer-dispersed liquid crystals that increase in degree of scattering with increase in the voltage applied between the pixel electrode 2 of each of the pixels Pix and the common electrode 6, or may be the polymer-dispersed liquid crystals that increase in degree of scattering with decrease in the voltage applied between the pixel electrode 2 of each of the pixels Pix and the common electrode 6.

As illustrated in FIG. 2, the light source device L is located on a lateral side of the display panel DISP (lower side of the display panel DISP in FIG. 1). The light source device L includes a light source 11 that emits light to a lateral surface of the display panel DISP and a light source drive circuit 12 that controls the light source 11. The light source 11 includes a first light source 11R, a second light source 11G, and a third light source 11B.

The first light source 11R, the second light source 11G, and the third light source 11B each emit light under the control of the light source drive circuit 12. The first light source 11R, the second light source 11G, and the third light source 11B are light sources using light-emitting elements such as light-emitting diodes (LEDs), but are not limited to such light sources, and only need to be light sources controllable in light emission timing.

The light source drive circuit 12 controls the light emission timing of the first light source 11R, the second light source 11G, and the third light source 11B under the control of the timing controller 13. In the present disclosure, the emission color of the first light source 11R (first color) is red (R), the emission color of the second light source 11G (second color) is green (G), and the emission color of the third light source 11B (third color) is blue (B).

When the light is emitted from the light source 11, the display area 7 is irradiated by the light (first color, second color, and third color) emitted from one lateral surface side in the Y direction. Each of the pixels Pix transmits or scatters the light emitted from the one lateral surface side in the Y direction. The degree of scattering of the liquid crystals 3 for each of the pixels Pix depends on the state of the liquid crystals 3 controlled according to the pixel signal for each of the pixels Pix.

The timing controller 13 is a circuit that controls the operation timing of the signal output circuit 8, the scan circuit 9, the VCOM drive circuit 10, and the light source drive circuit 12. In the present disclosure, the timing controller 13 operates based on signals received via the image processing circuit 70.

The image processing circuit 70 outputs signals based on display image data to the signal output circuit 8 and the timing controller 13. When the pixel data is assumed to be data indicating red-green-blue (RGB) gradation values assigned to one of the pixels Pix provided in the display area 7, the display image data supplied to the image processing circuit 70 to output an image for display is a set of a plurality of pieces of the pixel data for the respective pixels Pix in the display area 7. The image processing circuit 70 may be provided on one of the substrates included in the display panel DISP, may be mounted on a flexible printed circuit board provided with, for example, wiring extending from the display panel DISP, or may be provided outside the display panel DISP.

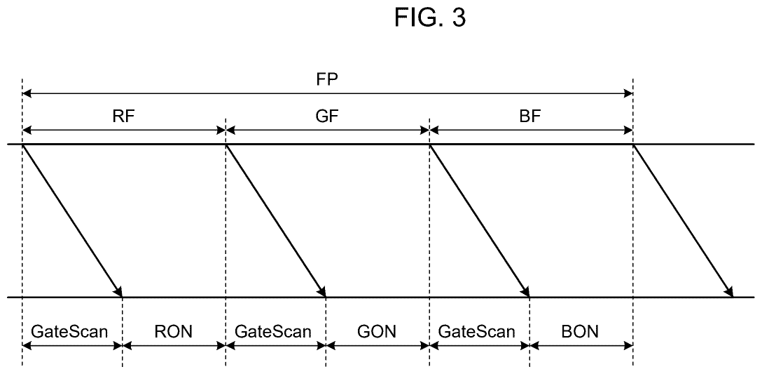

FIG. 3 is a timing diagram illustrating sub-frame periods and light emission periods in a one-frame period during which the display image data is displayed. In FIG. 3, an image display period FP for one frame is set to 20 ms. In this case, the image display frame rate of the display device 100 is set to 50 frames per second (fps).

In the display device 100 that performs the display output using the FSC system, the image display period FP for one frame based on the display image data is divided into a first sub-frame period RF, a second sub-frame period GF, and a third sub-frame period BF, as illustrated in FIG. 3. The first sub-frame period RF, the second sub-frame period GF, and the third sub-frame period BF are each set to 6.67 ms.

During a vertical scan period GateScan (first period) of the first sub-frame period RF, the pixel data corresponding to an output gradation value of each of the pixels Pix corresponding to the first color (red (R)) of the display image data is written. As a result, a voltage corresponding to the pixel data for each of the pixels Pix is applied to the pixel electrode 2 of the pixel Pix, and the scattering state of the liquid crystals 3 for each of the pixels Pix is controlled according to the voltage applied to the pixel electrode 2 of the pixel Pix. The vertical scan period GateScan (first period) of the first sub-frame period RF is set to 2.5 ms, for example.

The first light source 11R emits light during a subsequent light emission period RON (second period). During this light emission period RON (second period), light in the first color (red (R)) corresponding to the pixel data for each of the pixels Pix written in the previous vertical scan period GateScan is scattered and displayed.

During the vertical scan period GateScan (first period) of the second sub-frame period GF, the pixel data corresponding to an output gradation value of each of the pixels Pix corresponding to the second color (green (G)) of the display image data is written. As a result, a voltage corresponding to the pixel data for each of the pixels Pix is applied to the pixel electrode 2 of the pixel Pix, and the scattering state of the liquid crystals 3 for each of the pixels Pix is controlled according to the voltage applied to the pixel electrode 2 of the pixel Pix. The vertical scan period GateScan (first period) of the second sub-frame period GF is set to 2.5 ms, for example.

The second light source 11G emits light during a subsequent light emission period GON (second period). During this light emission period GON (second period), light in the second color (green (G)) corresponding to the pixel data for each of the pixels Pix written in the previous vertical scan period GateScan is scattered and displayed.

During the vertical scan period GateScan (first period) of the third sub-frame period BF, the pixel data corresponding to an output gradation value of each of the pixels Pix corresponding to the third color (blue (B)) of the display image data is written. As a result, a voltage corresponding to the pixel data for each of the pixels Pix is applied to the pixel electrode 2 of the pixel Pix, and the scattering state of the liquid crystals 3 for each of the pixels Pix is controlled according to the voltage applied to the pixel electrode 2 of the pixel Pix. The vertical scan period GateScan (first period) of the third sub-frame period BF is set to 2.5 ms, for example.

The third light source 11B emits light during a subsequent light emission period BON (second period). During this light emission period BON (second period), light in the third color (blue (B)) corresponding to the pixel data for each of the pixels Pix written in the previous vertical scan period GateScan is scattered and displayed.

In the display device 100 of the FSC system described above, an image in which three colors of the first color (red (R)), the second color (green (G)), and the third color (blue (B)) are combined (mixed) is recognized due to an afterimage phenomenon caused by limited temporal resolution of a human eye. Since the display device 100 of the FSC system need not be provided with a color filter for each of the pixels Pix, light transmittance in the display area 7 can be made higher.

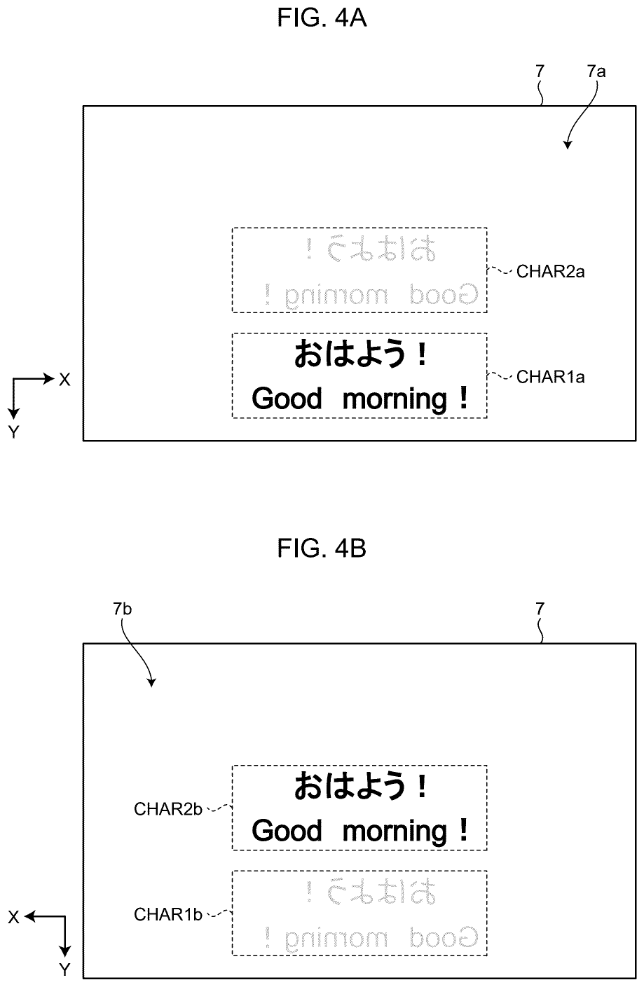

FIG. 4A is a conceptual view of a display state according to a comparative example as viewed in a first visual line direction. FIG. 4B is a conceptual view of the display state according to the comparative example as viewed in a second visual line direction.

As described above, the display panel DISP is configured to make a mirror image of an image viewed in plan view in the first visual line direction of the display area 7 visible from the other side. In other words, the image displayed on the first surface 7a of the display panel DISP as the display area 7 is viewed in plan view in the first visual line direction and the image displayed on the second surface 7b of the display panel DISP as the display area 7 is viewed in plan view in the second visual line direction are mirror images of each other.

FIG. 4A illustrates a display example on the first surface 7a of the display panel DISP as the display area 7 is viewed in plan view in the first visual line direction. FIG. 4B illustrates a display example on the second surface 7b of the display panel DISP as the display area 7 is viewed in plan view in the second visual line direction. These figures illustrate states in which the display panel DISP displays: first textual information CHAR1a that is legible when the first surface 7a of the display panel DISP is viewed in plan view in the first visual line direction; and second textual information CHAR2b that is legible when the second surface 7b of the display panel DISP is viewed in plan view in the second visual line direction.

The first textual information CHAR1a is visible as first textual information CHAR1b that is reversed as a mirror image when the second surface 7b of the display panel DISP is viewed in plan view in the second visual line direction. The second textual information CHAR2b is visible as second textual information CHAR2a that is reversed as a mirror image when the second surface 7b of the display panel DISP is viewed in plan view in the second visual line direction. Thus, in the display states illustrated in the comparative example, twice the size of the display area is required to ensure the legibility of textual information in both cases when the first surface 7aof the display panel DISP is viewed in the first visual line direction and when the second surface 7b of the display panel DISP is viewed in the second visual line direction. If, alternatively, the display area of the textual information is reduced, for example, by reducing the font size, the legibility of the text may be reduced.

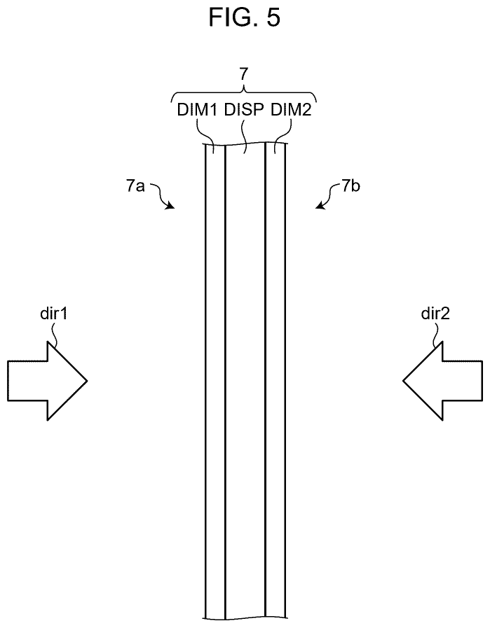

FIG. 5 is a schematic sectional view of the display area in the display device according to the embodiment. In the present disclosure, the first surface 7a of the display panel DISP, as viewed in plan view in a first visual line direction dir1, is provided with a first dimming panel (first light control panel) DIM1 that makes at least a partial area of the display area 7 invisible. In the present disclosure, the second surface 7b of the display panel DISP, as viewed in plan view in a second visual line direction dir2, is provided with a second dimming panel (second light control panel) DIM2 that makes at least a partial area of the display area 7 invisible.

The first dimming panel DIM1 and the second dimming panel DIM2 may, for example, be configured to transmit or block light emitted from the display panel DISP by controlling the orientation state of a liquid crystal layer. Alternatively, the first dimming panel DIM1 and the second dimming panel DIM2 may, for example, be configured to transmit or block the light emitted from the display panel DISP by controlling the degree of light transmittance of an electrochromic layer. The first dimming panel DIM1 and the second dimming panel DIM2 only need to be configured to be capable of making at least a partial area of the display area 7 invisible when the display area 7 is viewed in plan view in the first visual line direction dir1 or the second visual line direction dir2.

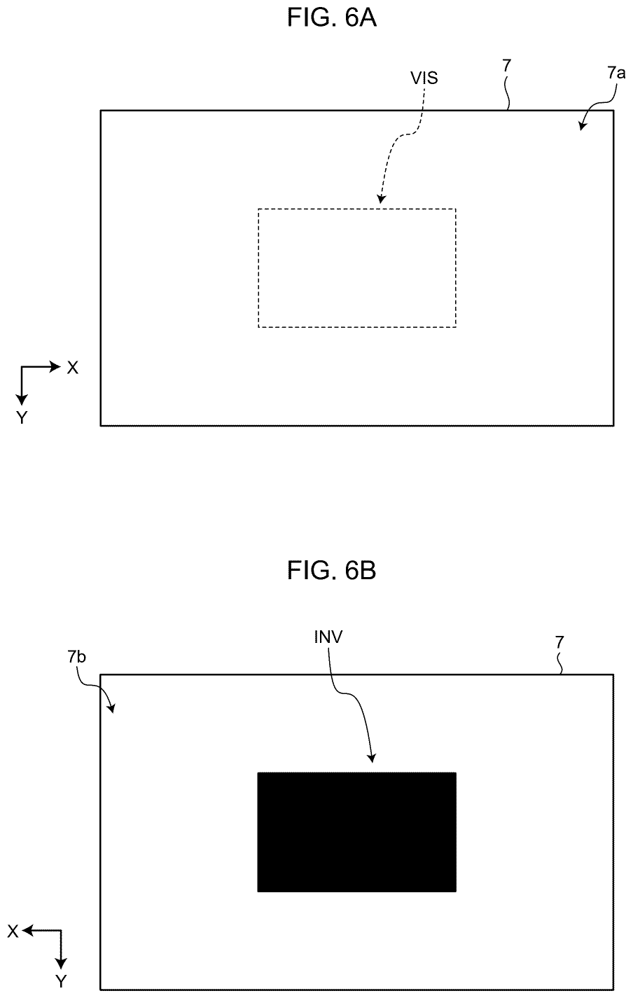

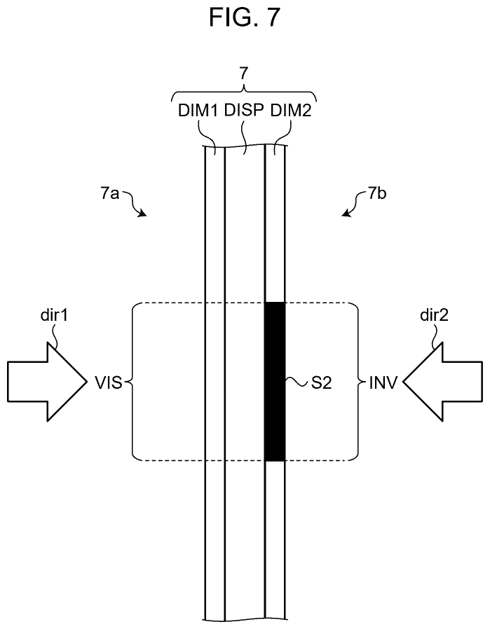

FIG. 6A is a conceptual view of a first display example according to the embodiment as viewed in the first visual line direction. FIG. 6B is a conceptual view of the first display example according to the embodiment as viewed in the second visual line direction. FIG. 7 is a schematic sectional view of the display area in the first display example illustrated in FIGS. 6A and 6B.

In the first display example, an area VIS made visible when the display area 7 is viewed in plan view in the first visual line direction dir1 and an area INV made invisible when the display area 7 is viewed in plan view in the second visual line direction dir2 overlap each other in the visual line direction. This configuration can make the first textual information CHAR1b that is visible as the mirror-image reversed textual information invisible, for example, when the second surface 7b of the display panel DISP is viewed in plan view in the second visual line direction.

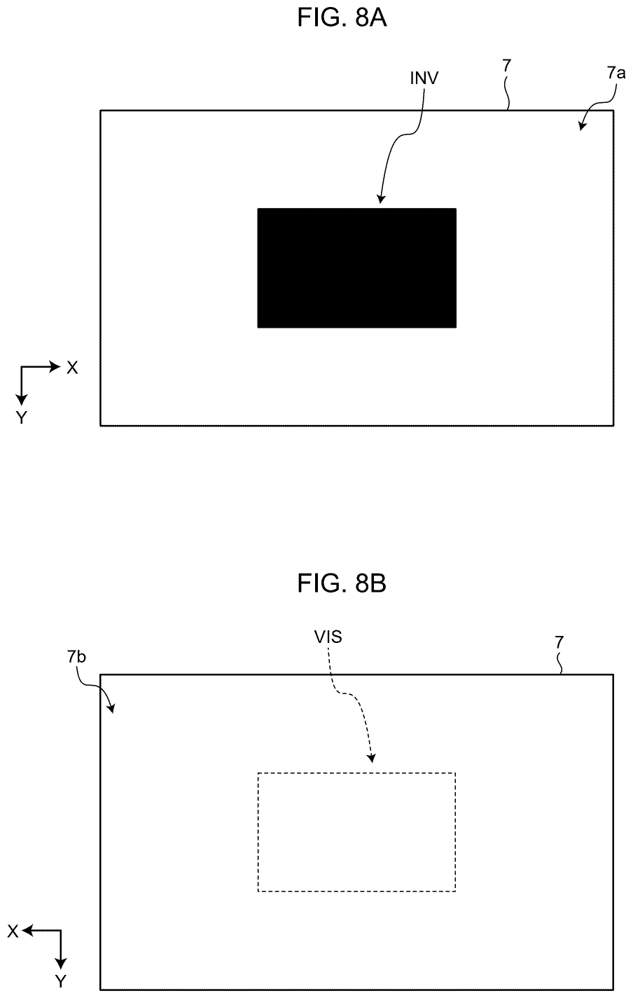

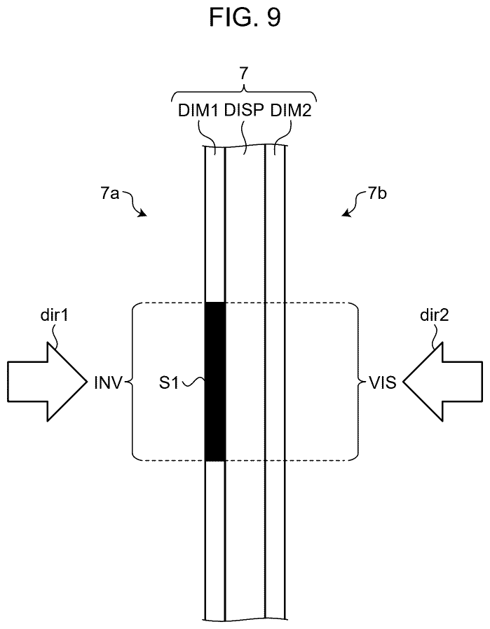

FIG. 8A is a conceptual view of a second display example according to the embodiment as viewed in the first visual line direction. FIG. 8B is a conceptual view of the second display example according to the embodiment as viewed in the second visual line direction. FIG. 9 is a schematic sectional view of the display area in the second display example illustrated in FIGS. 8A and 8B.

In the second display example, the area INV made invisible when the display area 7 is viewed in plan view in the first visual line direction dir1 and the area VIS made visible when the display area 7 is viewed in plan view in the second visual line direction dir2 overlap each other in the visual line direction. This configuration can make the second textual information CHAR2a that is visible as the mirror-image reversed textual information invisible, for example, when the first surface 7a of the display panel DISP is viewed in plan view in the first visual line direction.

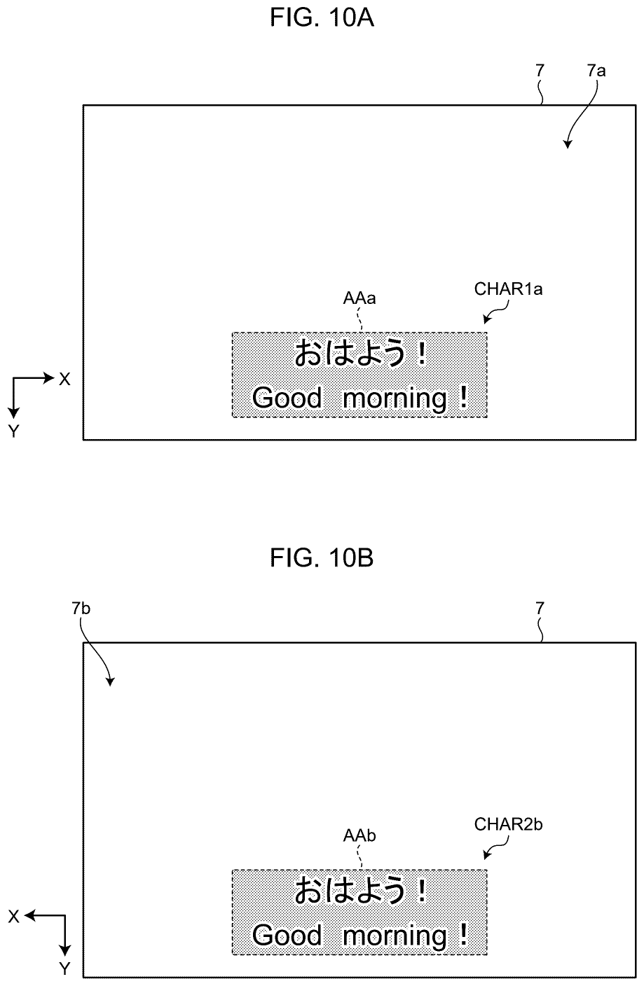

FIG. 10A is a conceptual view of a third display example according to the embodiment as viewed in the first visual line direction. FIG. 10B is a conceptual view of the third display example according to the embodiment as viewed in the second visual line direction.

FIG. 10A illustrates the example in which the first textual information CHAR1a that is legible when the display area 7 is viewed in plan view in the first visual line direction dir1 is made visible in a textual-information display area AAa on the first surface 7a of the display panel DISP when the display area 7 is viewed in plan view in the first visual line direction dir1. FIG. 10B illustrates the example in which the second textual information CHAR2b that is legible when the display area 7 is viewed in plan view in the second visual line direction dir2 is made visible in a textual-information display area AAb on the second surface 7b of the display panel DISP when the display area 7 is viewed in plan view in the second visual line direction dir2.

In the present embodiment, the textual-information display area AAa and the textual-information display area AAb are respectively provided on the first surface 7a and the second surface 7b of the display panel DISP serving as front and back sides of the same area. The mirror image (corresponding to CHAR1b illustrated in FIG. 4B) of the first textual information CHAR1a displayed in the textual-information display area AAa when the first surface 7a of the display panel DISP is viewed in plan view in the first visual line direction dir1, is not visible when the second surface 7b of the display panel DISP is viewed in plan view in the second visual line direction dir2. The mirror image (corresponding to CHAR2a illustrated in FIG. 4A) of the second textual information CHAR2b displayed in the textual-information display area AAb when the second surface 7b of the display panel DISP is viewed in plan view in the second visual line direction dir2, is not visible when the first surface 7a of the display panel DISP is viewed in plan view in the first visual line direction dir1.

The following describes a configuration that can achieve the display state of the third example according to the embodiment described above.

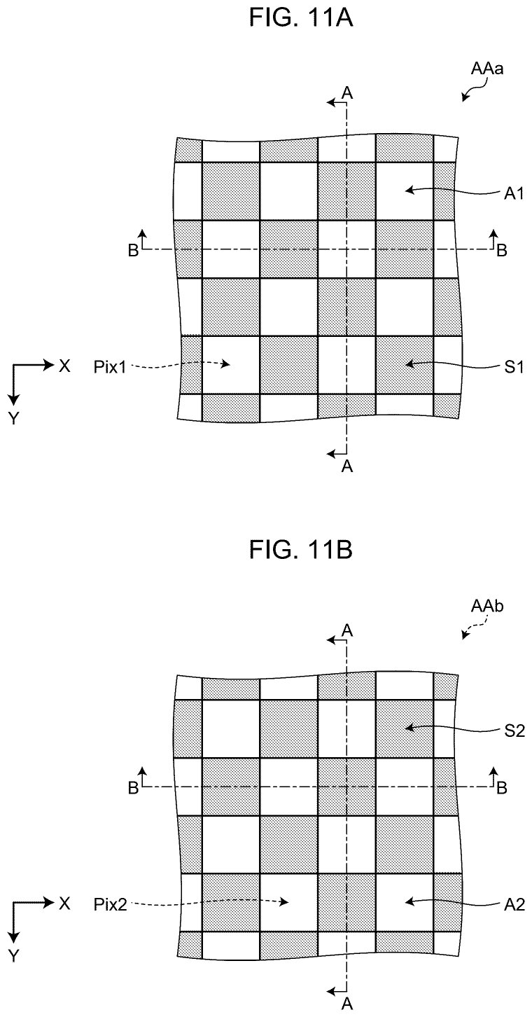

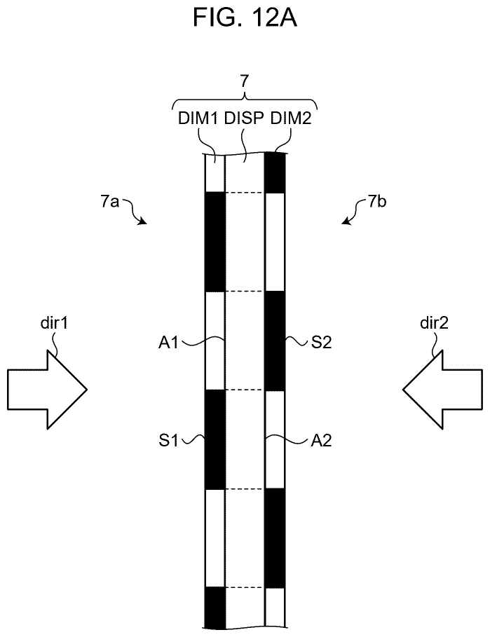

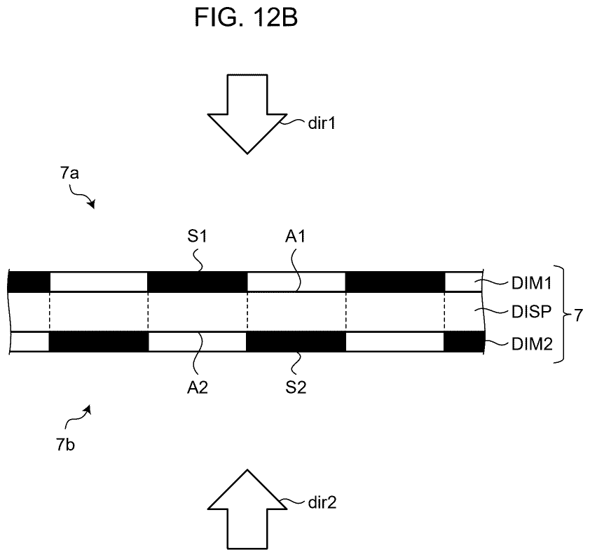

FIG. 11A is an enlarged view illustrating a first example of the textual-information display area in the third display example according to the embodiment as viewed in the first visual line direction. FIG. 11B is an enlarged view illustrating the first example of the textual-information display area in the third display example according to the embodiment as viewed in the second visual line direction. FIG. 12A is a sectional arrow view taken along line A-A illustrated in FIGS. 11A and 11B. FIG. 12B is a sectional arrow view taken along line B-B illustrated in FIGS. 11A and 11B.

FIG. 11A illustrates a first light-blocking pattern S1 when the textual-information display area AAa is viewed in plan view in the first visual line direction dir1. FIG. 11B illustrates a second light-blocking pattern S2 when the textual-information display area AAb is seen through in the first visual line direction dir1.

The textual-information display area AA (AAa, AAb) includes a plurality of first areas A1 and a plurality of second areas A2. The first areas A1 are made visible when the display area 7 is viewed in plan view in the first visual line direction dir1, and made invisible by the second light-blocking pattern S2 formed by the second dimming panel DIM2 provided on the second surface 7b side when the display area 7 is viewed in plan view in the second visual line direction dir2. The second areas A2 are made visible when the display area 7 is viewed in plan view in the second visual line direction dir2, and made invisible by the first light-blocking pattern S1 formed by the first dimming panel DIM1 provided on the first surface 7a side when the display area 7 is viewed in plan view in the first visual line direction dir1.

In the first example, the first areas A1 and the second areas A2 are provided so as to be alternately arranged in the X direction (first direction). The first areas A1 and the second areas A2 are provided so as to be alternately arranged also in the Y direction (second direction). In the first example, the first areas A1 and the second areas A2 each include at least one of the pixels Pix in the X direction (first direction). Each of the first areas A1 and the second areas A2 includes also at least one of the pixels Pix in the Y direction (second direction). As a result, the first areas A1 and the second areas A2 are arranged in a checkerboard pattern.

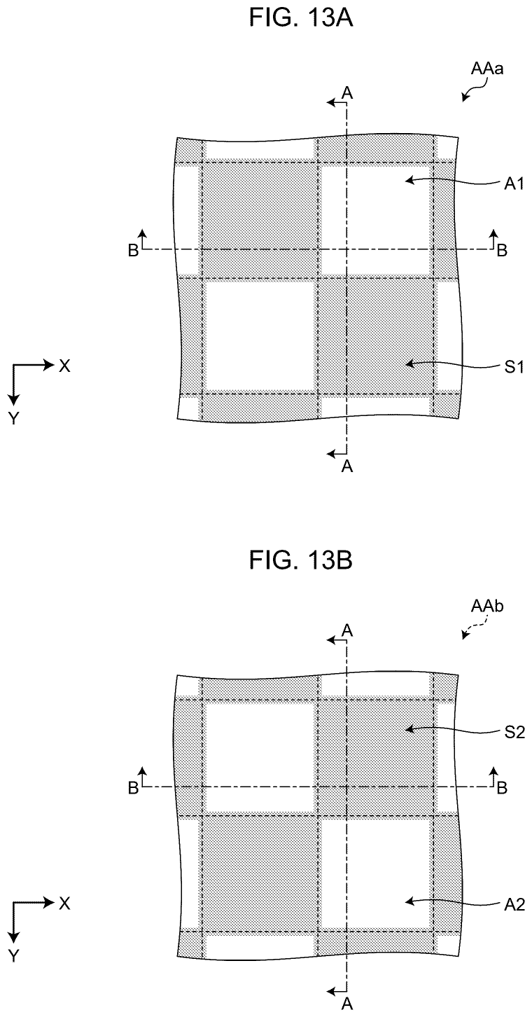

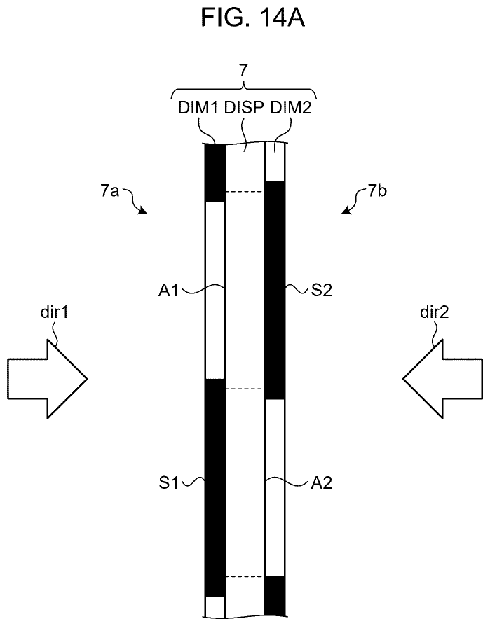

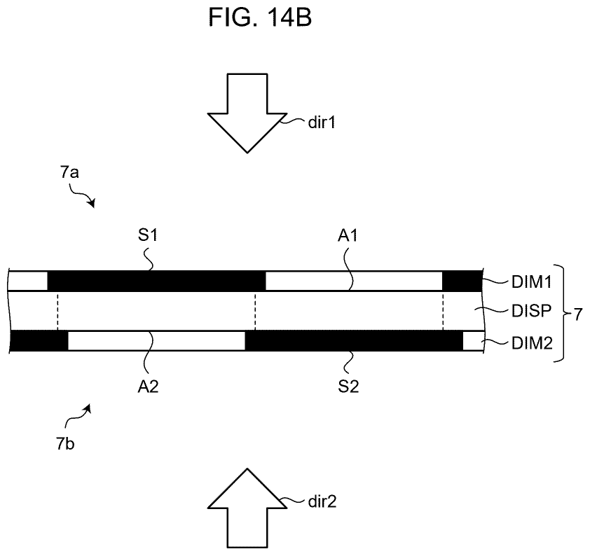

FIG. 13A is an enlarged view illustrating a second example of the textual-information display area in the third display example according to the embodiment as viewed in the first visual line direction. FIG. 13B is an enlarged view illustrating the second example of the textual-information display area in the third display example according to the embodiment as viewed in the second visual line direction. FIG. 14A is a sectional arrow view taken along line A-A illustrated in FIGS. 13A and 13B. FIG. 14B is a sectional arrow view taken along line B-B illustrated in FIGS. 13A and 13B.

FIG. 13A illustrates a first light-blocking pattern S1 when the textual-information display area AAa is viewed in plan view in the first visual line direction dir1. FIG. 13B illustrates the second light-blocking pattern S2 when the textual-information display area AAb is seen through in the first visual line direction dir1.

In the second example, the first areas A1 overlap the second areas A2 in predetermined areas including boundary lines between the first areas A1 and the second areas A2 indicated by dashed lines in plan view. This configuration can reduce light leakage in the second areas A2 when the first surface 7a of the display panel DISP is viewed in the first visual line direction dir1. Light leakage in the first areas A1 can also be reduced when the second surface 7b of the display panel DISP is viewed in the second visual line direction dir2.

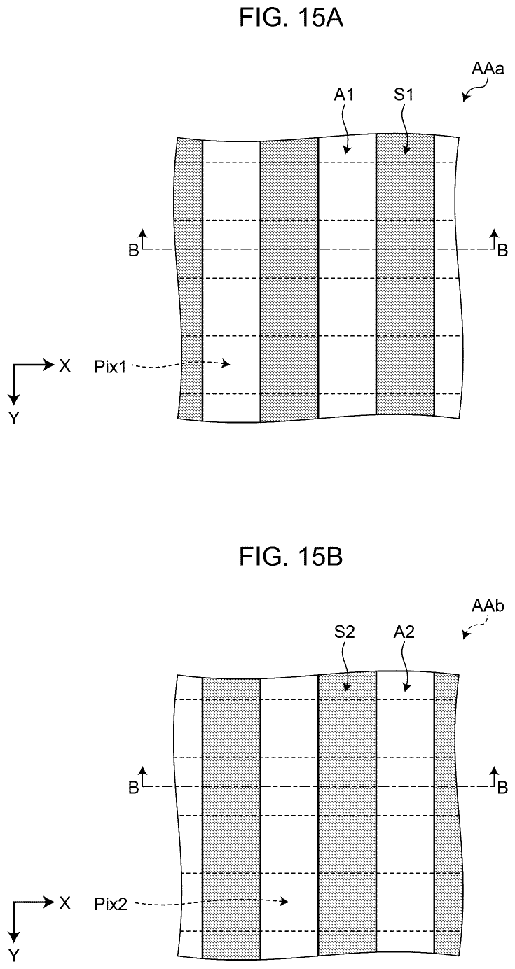

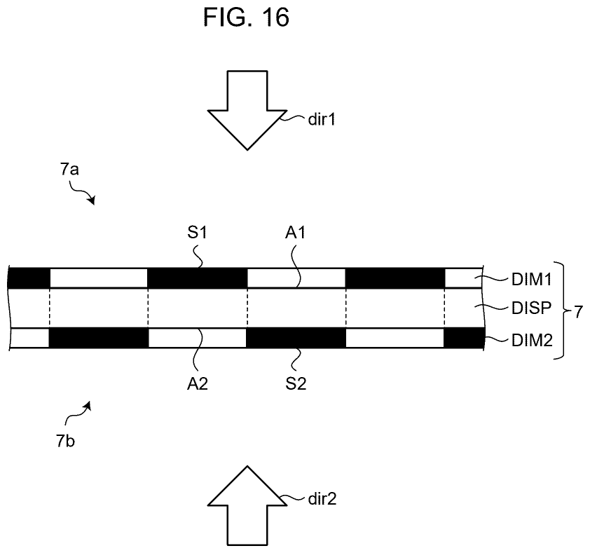

FIG. 15A is an enlarged view illustrating a third example of the textual-information display area in the third display example according to the embodiment as viewed in the first visual line direction. FIG. 15B is an enlarged view illustrating the third example of the textual-information display area in the third display example according to the embodiment as viewed in the second visual line direction. FIG. 16 is a sectional arrow view taken along line B-B illustrated in FIGS. 15A and 15B. FIG. 15A illustrates the first light-blocking pattern S1 when the textual-information display area AAa is viewed in plan view in the first visual line direction dir1. FIG. 15B illustrates the second light-blocking pattern S2 when the textual-information display area AAb is seen through in the first visual line direction dir1.

In the third example, the first areas A1 and the second areas A2 are provided so as to be alternately arranged in the X direction (first direction). In the third example, the first areas A1 and the second areas A2 each include at least one of the pixels Pix in the X direction (first direction). As a result, the first areas A1 and the second areas A2 are arranged in a vertical stripe pattern.

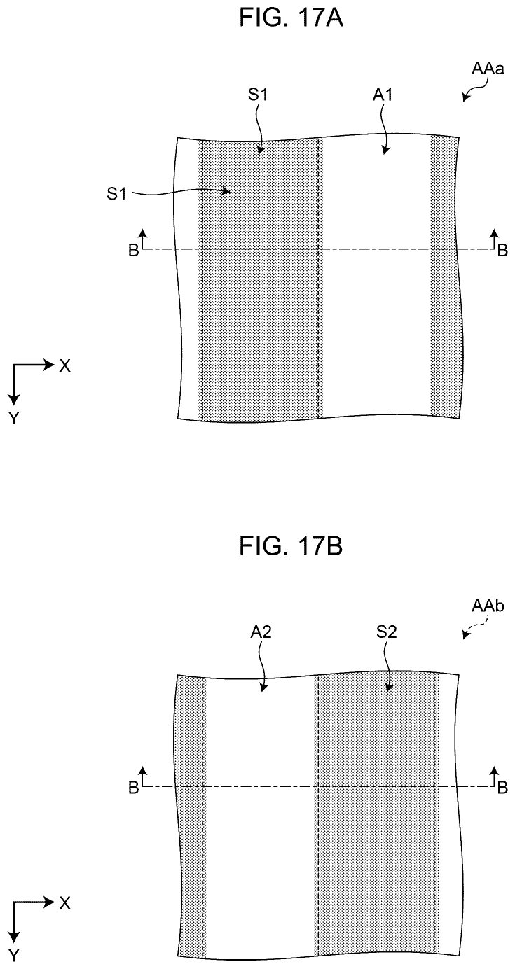

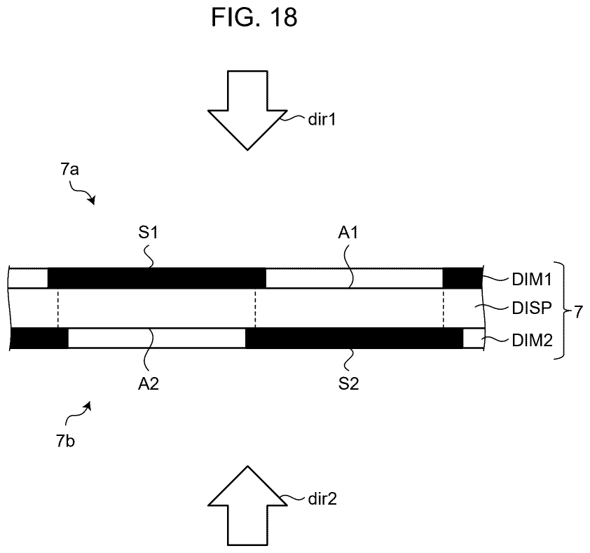

FIG. 17A is an enlarged view illustrating a fourth example of the textual-information display area in the third display example according to the embodiment as viewed in the first visual line direction. FIG. 17B is an enlarged view illustrating the fourth example of the textual-information display area in the third display example according to the embodiment as viewed in the second visual line direction. FIG. 18 is a sectional arrow view taken along line B-B illustrated in FIGS. 17A and 17B.

FIG. 17A illustrates the first light-blocking pattern S1 when the textual-information display area AAa is viewed in plan view in the first visual line direction dir1. FIG. 17B illustrates the second light-blocking pattern S2 when the textual-information display area AAb is seen through in the first visual line direction dir1.

In the fourth example, the first areas A1 overlap the second areas A2 in predetermined areas including boundary lines between the first areas A1 and the second areas A2 indicated by dashed lines in plan view. This configuration can reduce light leakage in the second areas A2 when the first surface 7a of the display panel DISP is viewed in the first visual line direction dir1. Light leakage in the first areas A1 can also be reduced when the second surface 7b of the display panel DISP is viewed in the second visual line direction dir2.

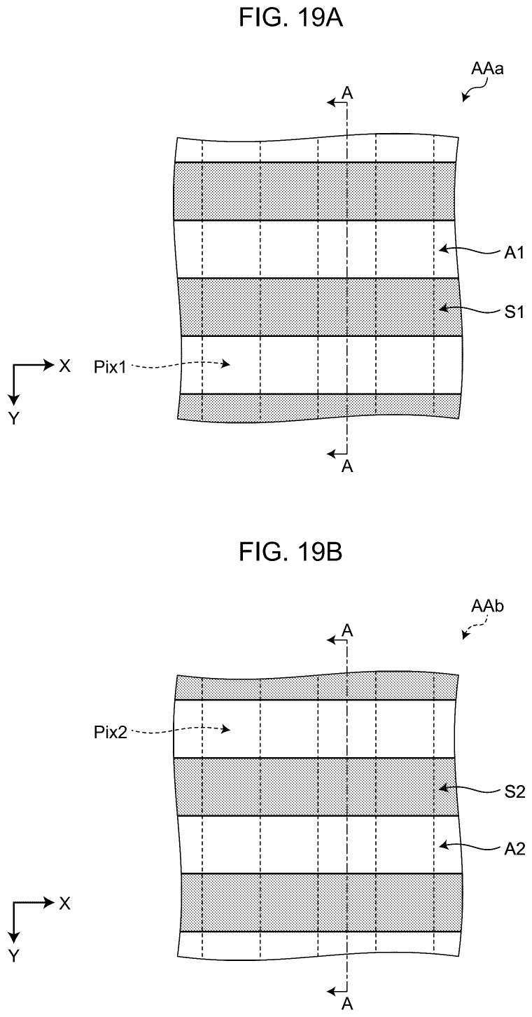

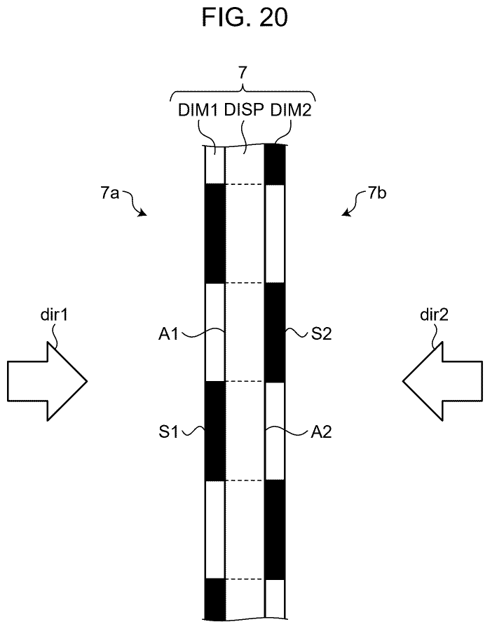

FIG. 19A is an enlarged view illustrating a fifth example of the textual-information display area in the third display example according to the embodiment as viewed in the first visual line direction. FIG. 19B is an enlarged view illustrating the fifth example of the textual-information display area in the third display example according to the embodiment as viewed in the second visual line direction. FIG. 20 is a sectional arrow view taken along line A-A illustrated in FIGS. 19A and 19B.

FIG. 19A illustrates the first light-blocking pattern S1 when the textual-information display area AAa is viewed in plan view in the first visual line direction dir1. FIG. 19B illustrates the second light-blocking pattern S2 when the textual-information display area AAb is seen through in the first visual line direction dir1.

In the fifth example, the first areas A1 and the second areas A2 are provided so as to be alternately arranged in the Y direction (second direction). In the fifth example, the first areas A1 and the second areas A2 each include at least one of the pixels Pix in the Y direction (second direction). As a result, the first areas A1 and the second areas A2 are arranged in a horizontal stripe pattern.

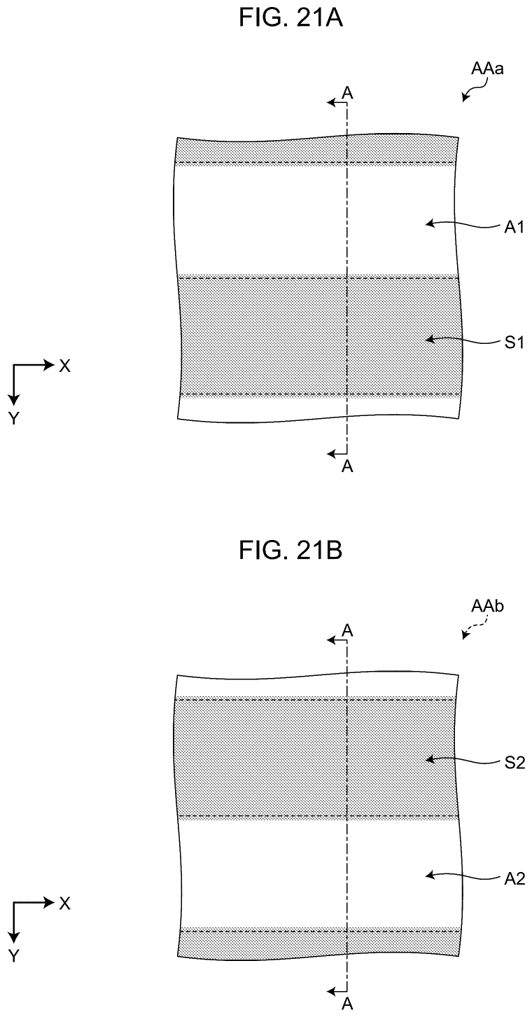

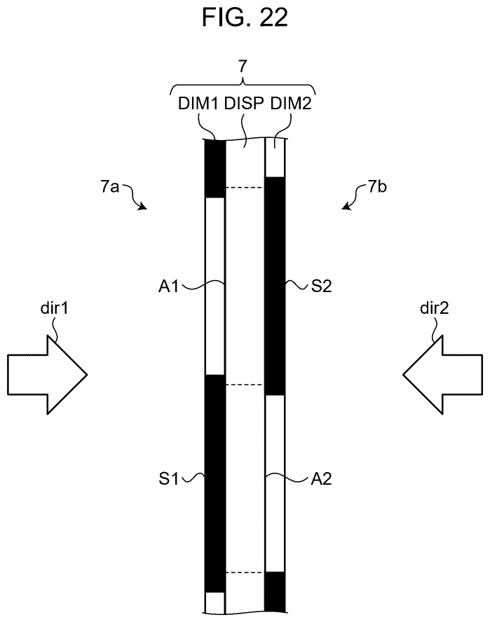

FIG. 21A is an enlarged view illustrating a sixth example of the textual-information display area in the third display example according to the embodiment as viewed in the first visual line direction. FIG. 21B is an enlarged view illustrating the sixth example of the textual-information display area in the third display example according to the embodiment as viewed in the second visual line direction. FIG. 22 is a sectional arrow view taken along line A-A illustrated in FIGS. 21A and 21B.

FIG. 21A illustrates the first light-blocking pattern S1 when the textual-information display area AAa is viewed in plan view in the first visual line direction dir1. FIG. 21B illustrates the second light-blocking pattern S2 when the textual-information display area AAb is seen through in the first visual line direction dir1.

In the sixth example, the first areas A1 overlap the second areas A2 in predetermined areas including boundary lines between the first areas A1 and the second areas A2 indicated by dashed lines in plan view. This configuration can reduce light leakage in the second areas A2 when the first surface 7a of the display panel DISP is viewed in the first visual line direction dir1. Light leakage in the first areas A1 can also be reduced when the second surface 7b of the display panel DISP is viewed in the second visual line direction dir2.

In the third example described above, the image processing circuit 70 performs image processing so that the first textual information CHAR1a is visible in the first visual line direction dir1 and the second textual information CHAR2b is visible in the second visual line direction dir2. The first textual information CHAR1a is legible when the first surface 7a of the display panel DISP is viewed in plan view in the first visual line direction dir1, and the second textual information CHAR2b is legible when the second surface 7b of the display panel DISP is viewed in plan view in the second visual line direction dir2.

In other words, pixels Pix2 corresponding to the second textual information CHAR2a that is the mirror image of the second textual information CHAR2b are masked by the first light-blocking pattern S1 formed by the first dimming panel DIM1 provided on the first surface 7a side when the first surface 7a of the display panel DISP is viewed in plan view in the first visual line direction dir1, and the first textual information CHAR1a that is legible in the first visual line direction dir1 is formed by pixels Pix1 corresponding to the first areas A1 as an image displayed in the textual-information display area AAa when the first surface 7a of the display panel DISP is viewed in plan view in the first visual line direction dir1.

The pixels Pix1 corresponding to the first textual information CHAR1b that is the mirror image of the first textual information CHAR1a are masked by the second light-blocking pattern S2 formed by the second dimming panel DIM2 provided on the second surface 7b side when the second surface 7b of the display panel DISP is viewed in plan view in the second visual line direction dir2, and the second textual information CHAR2b that is legible in the second visual line direction dir2 is formed by the pixels Pix2 corresponding to the second areas A2 as an image displayed in the textual-information display area AAb when the second surface 7b of the display panel DISP is viewed in plan view in the second visual line direction dir2.

As a result, in both cases when the first surface 7aof the display panel DISP is viewed from the one side and when the second surface 7b of the display panel DISP is viewed from the other side, the legibility can be ensured while optimizing the display area and the font size of the textual information. Since no mirror image text is visible, the visibility of the entire image can be enhanced.

The above embodiment has described an example in which the mirror image of the legible first textual information CHAR1a (first textual information CHAR1b) that is visible when viewed in plan view in the first visual line direction dir1 is made invisible by being masked by the second light-blocking pattern S2 formed by the second dimming panel DIM2 provided on the second surface 7b side, and the mirror image of the legible second textual information CHAR2b (second textual information CHAR2a) that is visible when viewed in plan view in the second visual line direction dir2 made invisible by being masked by the first light-blocking pattern S1 formed by the first dimming panel DIM1 provided on the first surface 7a side. However, the image information made invisible by the first dimming panel DIM1 or the second dimming panel DIM2 is not limited to the mirror image of the textual information. For example, image information, such as two-dimensional image information such as a map including direction information and so forth or a two-dimensional code can be made invisible. Furthermore, content creators can intentionally create display content that is visible from only one point of view. In other words, the flexibility of the content displayed on the display device 100 according to the embodiment can be increased.

While the exemplary transmissive liquid crystal display device that performs the display output using the FSC system has been described, the display panel DISP is not limited to being configured as the liquid crystal display device using the FSC system. The display panel DISP may be, for example, a transmissive color liquid crystal display panel in which each pixel is constituted by a first sub-pixel, a second sub-pixel, and a third sub-pixel. A first color filter that transmits a first color (for example, red (R)) overlaps the first sub-pixel, the second color filter that transmits a second color (for example, green (G)) overlaps the second sub-pixel, and the third color filter that transmits a third color (for example, blue (B)) overlaps the third sub-pixel. In this case, the first areas A1 and the second areas A2 each only need to include the first sub-pixel, the second sub-pixel, and the third sub-pixel as one unit. Alternatively, the display panel DISP may be configured, for example, as a self-luminous organic EL display device.

While the preferred embodiment of the present disclosure has been described above, the present disclosure is not limited to such an embodiment. The content disclosed in the embodiment is merely an example, and can be variously modified within the scope not departing from the gist of the present disclosure. For example, any modifications appropriately made within the scope not departing from the gist of the present disclosure also naturally belong to the technical scope of the present invention.

What is claimed is:

1. A display device comprising:
a display panel that has a display area in which a plurality of pixels are arranged in a first direction and a second direction intersecting the first direction, and that is configured to make an image viewed in plan view from one side of the display area visible from another side;
a first light control panel that is provided on one surface of the display panel and is configured to make at least a partial area of the display area invisible; and
a second light control panel that is provided on another surface of the display panel and is configured to make at least a partial area of the display area invisible.

2. The display device according to claim 1, wherein at least one of the first light control panel and the second light control panel is provided with an electrochromic layer overlapping the display area.

3. The display device according to claim 1, wherein at least one of the first light control panel and the second light control panel is provided with a liquid crystal layer overlapping the display area.

4. The display device according to claim 1, wherein an area made visible by the first light control panel overlaps an area made invisible by the second light control panel in a visual line direction.

5. The display device according to claim 1, wherein an area made invisible by the first light control panel overlaps an area made visible by the second light control panel in a visual line direction.

6. The display device according to claim 1, wherein a first area that is made visible by the first light control panel and made invisible by the second light control panel and a second area that is made invisible by the first light control panel and made visible by the second light control panel are alternately arranged in the first direction and the second direction.

7. The display device according to claim 6, wherein
each of the first area and the second area comprises at least one pixel in the first direction, and
each of the first area and the second area comprises at least one pixel in the second direction.

8. The display device according to claim 7, wherein the first area overlaps the second area in a predetermined area including a boundary line between the first area and the second area in plan view.

9. The display device according to claim 1, wherein a first area that is made visible by the first light control panel and made invisible by the second light control panel and a second area that is made invisible by the first light control panel and made visible by the second light control panel are alternately arranged in the first direction.

10. The display device according to claim 9, wherein each of the first area and the second area comprises at least one pixel in the first direction.

11. The display device according to claim 10, wherein the first area overlaps the second area in a predetermined area including a boundary line between the first area and the second area in plan view.

12. The display device according to claim 1, wherein a first area that is made visible by the first light control panel and made invisible by the second light control panel and a second area that is made invisible by the first light control panel and made visible by the second light control panel are alternately arranged in the second direction.

13. The display device according to claim 12, wherein the first area and the second area each comprise at least one pixel in the second direction.

14. The display device according to claim 13, wherein the first area overlaps the second area in a predetermined area including a boundary line between the first area and the second area in plan view.
